(19) United States
(12) Patent Application Publication
(10) Pub. No.: US 2016/0299703 A1
(43) Pub. Date: Oct. 13, 2016

(54) I/O PERFORMANCE IN RAID STORAGE SYSTEMS THAT HAVE INCONSISTENT DATA

(71) Applicant: Avago Technologies General IP (Singapore) Pte. Ltd., San Jose, CA (US)

(72) Inventors: Santhosh Mysore Nagendra, Banaglore (IN); Naveen Krishnamurthy, Bangalore (IN)

(21) Appl. No.: 14/680,611

(22) Filed: Apr. 7, 2015

(51) Int. Cl. G06F 3/06

(52) U.S. Cl. CPC G06F 3/0613; G06F 3/0632; G06F 3/0659; G06F 3/0689

(57) ABSTRACT

Embodiments herein provide for data storage where inconsistent data exists. In one embodiment, a method comprises configuring a plurality of storage devices to operate as a Redundant Array of Independent Disks (RAID) storage system and initiating the RAID storage system to process Input/Output (I/O) requests from a host system to the storage devices. The method also comprises identifying where RAID consistent data exists after the RAID storage system is initiated, performing read-modify-write operations for write I/O requests directed to the RAID consistent data according to a marker identifying where the RAID consistent data exists, and performing a different type of write operations for write I/O requests directed to the inconsistent data according to the marker in order to make the inconsistent data RAID consistent. The marker is adjusted when the inconsistent data is made RAID consistent.

### FIELD OF THE INVENTION

The invention generally relates to Redundant Array of Independent Disk (RAID) storage systems.

### BACKGROUND

In RAID storage, a virtual drive is created using the combined capacity of multiple storage devices, such as hard disk drives (HDDs) and solid state drives (SSDs). Some of the storage devices may comprise old data that is not relevant to a new virtual drive creation because the storage devices were part of a previous configuration. So, a virtual drive is initialized by clearing the old data before it is made available to a host system for data storage. Generally, there are two ways of initializing a virtual drive—completely clearing the data from the storage devices by writing logical zeros to the storage devices, or by clearing the first and last eight Megabytes (MB) of data in the virtual drive to wipe out the master boot record. However, completely clearing the data requires a substantial time commitment before the virtual drive can be made available to the host system. And, clearing the first and last eight Megabytes of data leaves an inconsistent virtual drive with old data that still needs to be cleared during storage operations which slows I/O performance.

### SUMMARY

Systems and methods presented herein improve I/O performance in RAID storage systems that comprise inconsistent data. In one embodiment, a method includes configuring a plurality of storage devices to operate as a RAID storage system and initiating the RAID storage system to process I/O requests from a host system to the storage devices. The method also includes identifying where RAID consistent data exists after the RAID storage system is initiated, and performing read-modify-write operations for write I/O requests directed to the RAID consistent data according to a marker that identifies where the RAID consistent data exists. Then, if a write I/O request is directed to the inconsistent data based on the marker, the inconsistent data is made RAID consistent using a different type of write operation and the marker position is adjusted to where the inconsistent data was made RAID consistent.

The various embodiments disclosed herein may be implemented in a variety of ways as a matter of design choice. For example, some embodiments herein are implemented in hardware whereas other embodiments may include processes that are operable to implement and/or operate the hardware. Other exemplary embodiments, including software and firmware, are described below.

### BRIEF DESCRIPTION OF THE FIGURES

Some embodiments of the present invention are now described, by way of example only, and with reference to the accompanying drawings. The same reference number represents the same element or the same type of element on all drawings.

FIG. 1 is a block diagram of an exemplary storage system.

FIG. 2 is a flowchart of an exemplary process of the storage system of FIG. 1.

FIG. 3 is a block diagram of storage devices in an exemplary RAID level 5 configuration illustrating data being written via a read-modify-write algorithm.

FIG. 4 is a block diagram of storage devices in an exemplary RAID level 5 configuration illustrating data being written via a read-peers-write algorithm.

FIG. 5 is a block diagram of storage devices in an exemplary RAID level 5 configuration illustrating a marker used to separate consistent data from inconsistent data.

FIG. 6 illustrates an exemplary computer system operable to execute programmed instructions to perform desired functions described herein.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention and are to be construed as being without limitation to such specifically recited examples and conditions. As a result, the invention is not limited to the specific embodiments or examples described below.

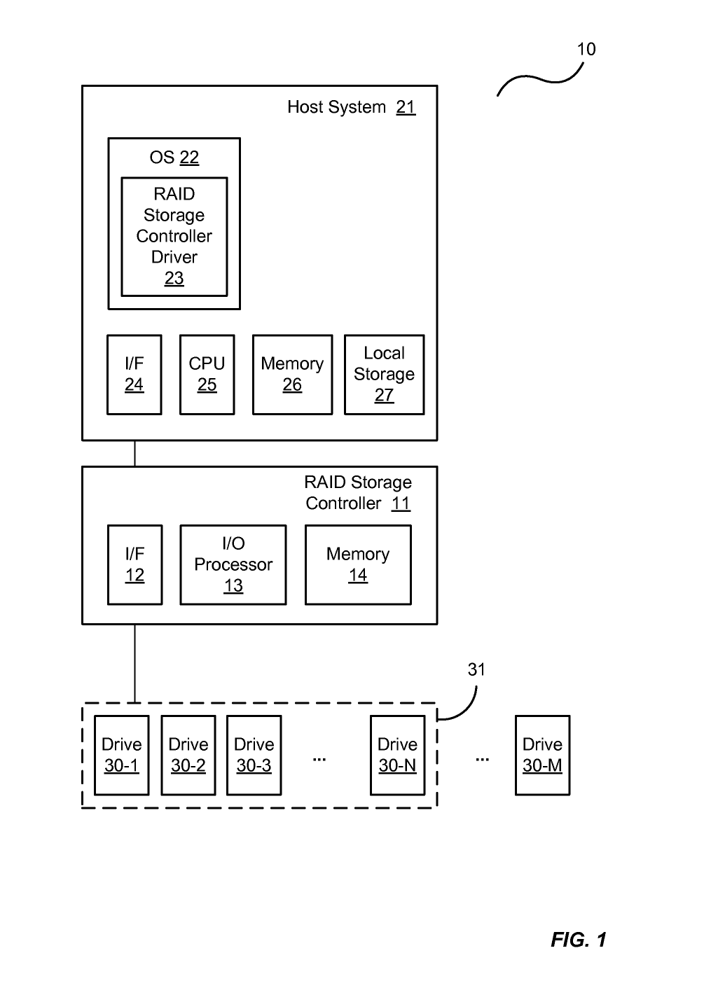

FIG. 1 is a block diagram of an exemplary storage system 10. In this embodiment, the storage system employs RAID storage management techniques wherein a plurality of drives (i.e., storage devices) 30 are virtualized to the drives as a single logical unit. For example, the RAID storage controller 11 illustrated herein may aggregate some portion of the drives 30-M (e.g., the drives 30-1-30-N) into a logical unit that a host system 21 sees as a single virtual drive 31. Once the virtual drive 31 is presented to the host system 21, the RAID storage controller 11 processes I/O requests from the host system 21 to the virtual drive 31. And, in doing so, the RAID storage controller 11 routes the I/O requests to the various individual drives 30 of the virtual drive 31 based on the RAID management technique being implemented (e.g., RAID levels 0-6).

Generally, the RAID storage controller 11 comprises an interface 12 that physically couples to the drives 30 and an I/O processor 13 that processes the I/O requests from the host system 21. The RAID storage controller 11 may also include some form of memory 14 that is used to cache data of I/O requests from the host system 21. The RAID storage controller 11 may be a device that is separate from the host system 21 (e.g., a Peripheral Component Interconnect Express “PCIe” card, a Serial Attached Small Computer System Interface “SAS” card, or the like). Alternatively, the RAID storage controller 11 may be implemented as part of the host system 21. Thus, the RAID storage controller 11 is any device, system, software, or combination thereof operable to aggregate a plurality of drives 30 into a single logical unit and implement RAID storage management techniques on the drives 30 of that logical unit.

The host system 21 may be implemented in a variety of ways. For example, the host system 21 may be a standalone computer. Alternatively, the host system 21 may be a network server that allows a plurality of users to store data within the virtual drive 31 through the RAID storage controller 11. In either case, the host system 21 typically comprises an operating system (OS) 22, and an interface 24, a central processing unit (CPU) 25, a memory module 26, and local storage 27 (e.g., an HDD, an SSD, or the like).

The OS 22 may include a RAID storage controller driver 23 that is operable to assist in generating the I/O requests to the RAID storage controller 11. For example, when the host system 21 wishes to write data to the virtual drive 31, the RAID storage controller driver 23 may generate a write I/O request on behalf of the host system 21 to the virtual drive 31. The write I/O request may include information that the RAID storage controller 11 maps to the appropriate drive 30 of the virtual drive according to the RAID management technique being implemented. The host system 21 then transfers the I/O request through the interface 24 for processing by the RAID storage controller 11 and routing of the data therein to the appropriate drive 30.

The RAID storage controller 11 is also responsible for initiating the virtual drive 31 and ensuring that data in the virtual drive is consistent with the RAID storage management technique being implemented. For example, one or more of the drives 30 may include “old” data because the drives 30 were part of another storage configuration. As such, that data needs to be made consistent with the RAID storage management technique being presently implemented, including calculating any needed RAID parity. In one embodiment, the RAID storage controller 11 generates and maintains a marker so as to identify which portions of the virtual drive 31 comprise data that is consistent with the present RAID storage management implementation and which portions of the virtual drive 31 comprise inconsistent data.

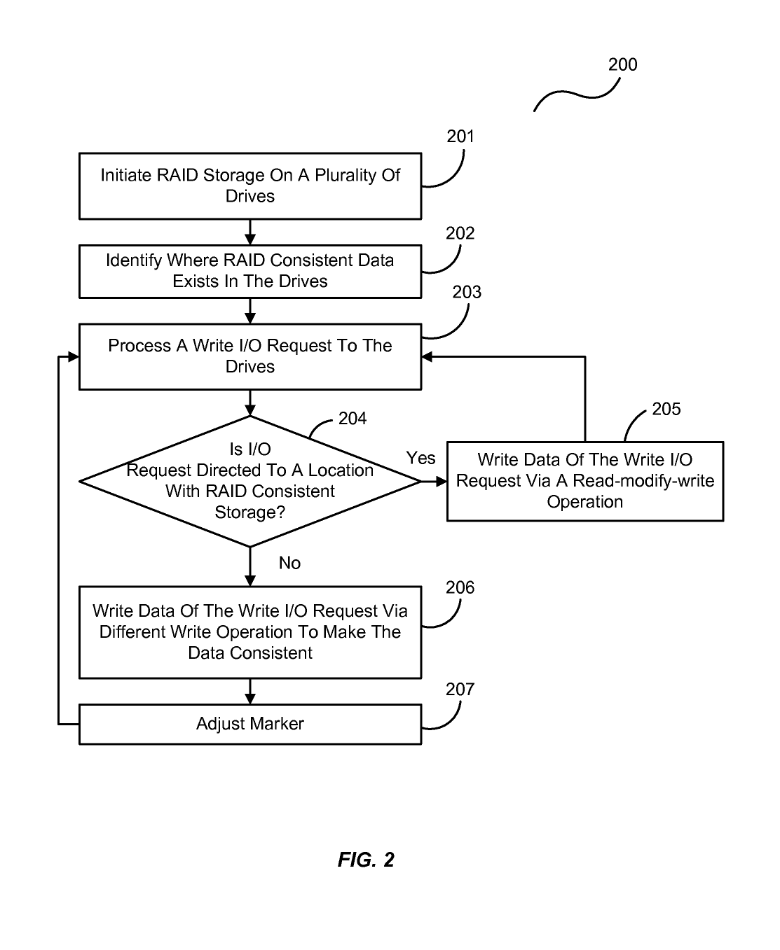

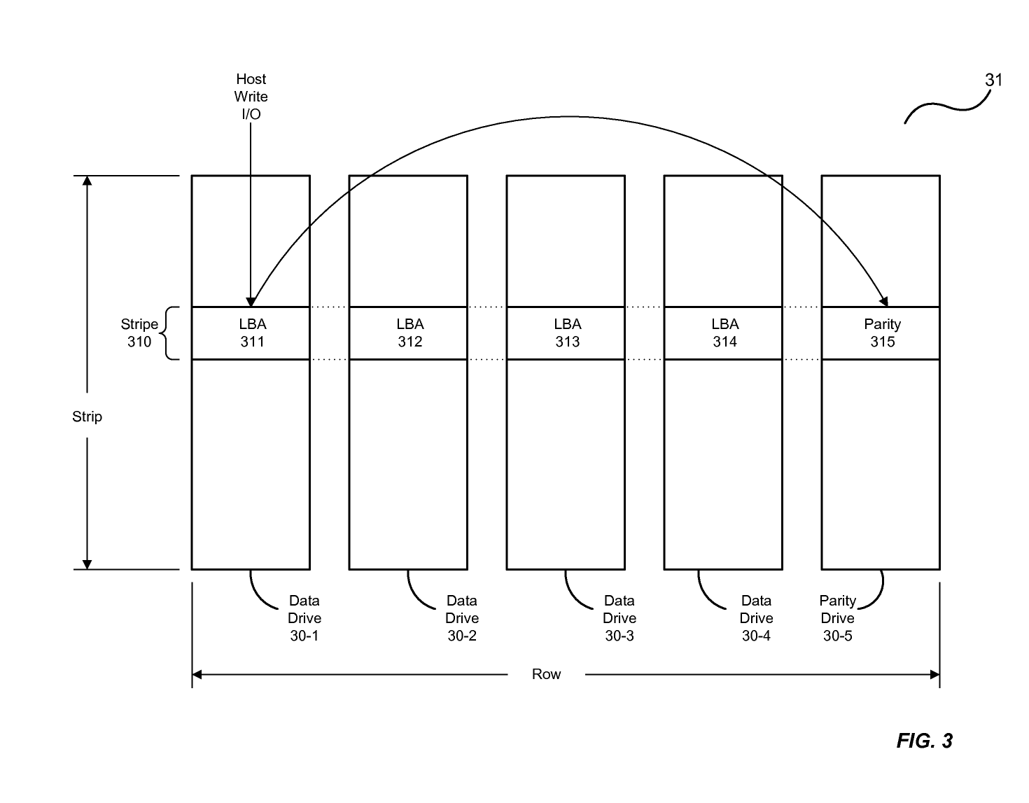

Examples of the drives 30-1-30-M include HDDs, SSDs, and the like. The references “M” and “N” are merely intended to represent integers greater than the “1” and not necessarily equal to any other “N” or “M” references designated herein. Additional details regarding the operations of the RAID storage controller 11 are shown and described below in FIGS. 3-5. One exemplary operation, however, is now shown and described with respect to the flowchart of FIG. 2. First a brief explanation is presented regarding how a storage system employing I/O caching to improve I/O performance can experience I/O latency when a virtual drive comprises inconsistent data.

Current RAID storage controllers use caching to improve I/O performance (e.g., via relatively fast onboard double data rate “DDR” memory modules). For example, virtual drives, such as the virtual drive 31, can be quickly implemented with “write-back” caching using the DDR caching modules so long as the data is RAID consistent. Write I/O requests to the virtual drive 31 by the host system 21 can then be immediately completed after writing to the DDR caching module to increase the write time performance.

But, an inherent latency can exist for a virtual drive being configured in write-back mode. For example, a full stripe of data for a virtual drive involves a strip of data across all of the physical drives that are used to form the RAID virtual drive. Background cache flushing operations involve blocking a full stripe of data without regard to a number of strips that need to be flushed from cache memory. This is followed by allocating cache lines for the strips of data that are not already available in the cache and then calculating any necessary parity before cache flushing of the data to the physical drives can occur. During the cache flush operation, if a write I/O request is directed to a strip of the stripe that is being flushed, the write I/O request waits until the cache flush is completed. And, if the write I/O request is directed a stripe with inconsistent data, the parity needs to be calculated, thereby increasing the I/O latency.

Some of the problems associated with these I/O latency conditions are overcome through embodiments disclosed herein. In FIG. 2, a flowchart illustrates one exemplary process 200 of the storage system 10 of FIG. 1. that uses multiple forms of writing data to the physical drives 30 based on whether the data of a given write I/O request is directed to RAID consistent data or inconsistent data in the virtual drive 31. In this embodiment, the RAID storage controller 11 initiates RAID storage on a plurality of drives 30 (e.g., the drives 30-1-30-N), in the process element 201. In doing so, the RAID storage controller 11 clears a portion of any existing data on the drives 30. For example, the RAID storage controller 11 may erase the first and last 8 MB of data on the virtual drive 31 by writing logical “Os” to those areas to wipe out the master boot record and/or any existing partition tables so as to quickly present the virtual drive 31 to the host system 21 for storage operations (i.e., read and write I/O requests).

Accordingly, some old data may remain with the newly created virtual drive 31. The RAID storage controller 11 identifies where RAID consistent data exists in the drives 30, and thus the virtual drive 31, in the process element 202. In doing so, the storage controller 11 generates and maintains (i.e., updates) a marker identifying the boundary between the RAID consistent data and the inconsistent data.

Thereafter, the RAID storage controller 11 processes a write I/O request to the drives 30 based on the host write I/O request to the virtual drive 31, in the process element 203. When the storage controller 11 receives the write I/O request, the storage controller 11 determines whether the write I/O request is directed to a location having RAID consistent storage, in the process element 204. For example, the RAID storage controller 11 may process a host write I/O request to the virtual drive 31 generated by the RAID storage controller driver 23 to determine a particular logical block address (LBA) of a particular physical drive 30. The RAID storage controller 11 may then compare that location to the marker to determine whether the write I/O request is directed to storage space that comprises RAID consistent data. If so, the RAID storage controller 11 writes the data of the write I/O request via a read-modify-write operation to the LBA of the write I/O request, in the process element 205.

If, however, the write I/O request is directed to storage space that comprises inconsistent data, then the RAID storage controller 11 writes the data of the write I/O request using a different write operation to make the data consistent, in the process element 206. For example, in the case of a RAID level 5 virtual drive in a write-back mode configuration, a read-modify-write operation to consistent data is operable to compute the necessary RAID level 5 parity for the stripe to which the write I/O request is directed. This allows the cache flush operation to be more quickly performed, which in turn decreases I/O latency. And, the storage controller 11 can clear old or inconsistent data in the background (e.g., via the storage controller driver 23 in between write operations). But, the read-modify-write operation is not effective in calculating the parity when inconsistent data exists where write I/O requests are directed. Instead, a more complicated and somewhat slower write operation may be used to calculate the necessary parity, albeit in a more selective fashion. That is, the storage controller 11, based on a marker that identifies the boundary between RAID consistent data and inconsistent data, can selectively implement different write operations based on individual write I/O requests. Afterwards, the marker is adjusted to indicate that the recently inconsistent data has been made RAID consistent, in the process element 207.

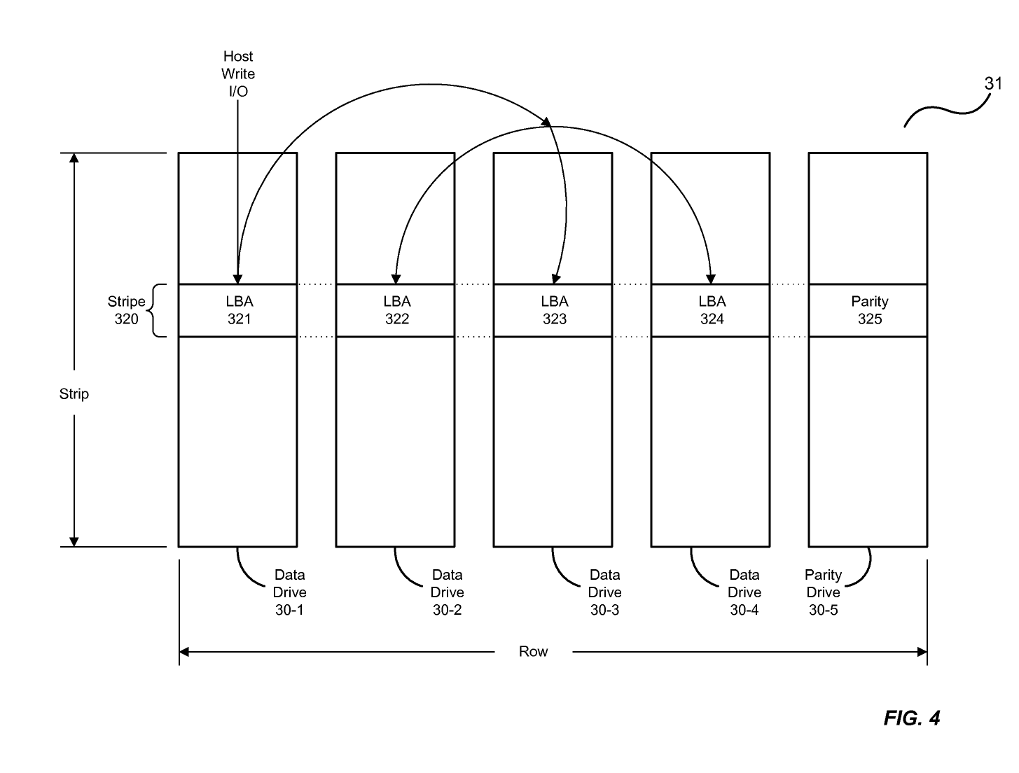

FIGS. 3 and 4 are block diagrams illustrating exemplary write operations that may be implemented with the storage controller 11 to make data RAID consistent in a storage system. More specifically, FIG. 3 is a block diagram of storage devices (i.e., the drives 30-1-30-5) in a RAID level 5 configuration (i.e., virtual drive 31) illustrating data being written via a read-modify-write algorithm whereas FIG. 4 is a block diagram of the storage devices in a RAID level 5 configuration illustrating data being written via a read-peers-write algorithm.

The read-modify-write operation of FIG. 3 as mentioned is used to write data to storage devices when the write I/O requests by the host system 21 are directed to RAID consistent data. The read-peers-write algorithm of FIG. 4 may be used when the write I/O requests are directed to inconsistent data. Generally, a read-modify-write operation for any given write I/O request involves two reads and two writes, whereas the read-peers-write algorithm involves three or more reads and two writes.

The read-peers-write algorithm could be used for any write I/O request to make the data in the virtual drive 31 RAID consistent throughout. However, this increases the number of reads that are performed during any write I/O request, increasing the I/O latency. And this increased I/O latency is directly proportional to the number of physical drives 30 used to create the virtual drive 31. The virtual drive 31 may also be made RAID consistent by clearing all of the existing data of the storage devices in the virtual drive 31. But, as mentioned, this entails writing logical “Os” to every LBA in the virtual drive 31, a time-consuming process.

In these embodiments, the read-modify-write operations and the read-peers-write operations are selectively used based on where the write I/O request from the host system 21 is directed (i.e., to RAID consistent data or inconsistent data, respectively). First, a relatively fast initialization is performed on the virtual drive 31 by the RAID storage controller 11 by erasing the first and last 8 MB of the data on the virtual drive 31 (e.g., to erase any existing master boot record or partition files). Then, the virtual drive 31 is presented to the host system 21 for write I/O operations. In the meantime, the RAID storage controller driver 23 may be operating in the background to clear other existing data from the physical drives 30 (e.g., by writing logical “Os” to the regions of the physical drives 30 where inconsistent data exists). And, the RAID storage controller 11 maintains a marker that indicates the separation between the RAID consistent data and the inconsistent data.

With this in mind, an exemplary read-modify-write operation is illustrated with the drives 30 of the virtual drive 31 in FIG. 3. Assume, in this embodiment, that the stripe 310 across the drives 30-1-30-5 comprises RAID consistent data at the LBAs 311-314 and that the RAID level 5 parity at the LBA 315 has thus already been established. Then, when the RAID storage controller 11 receives a write I/O request from the host system 21, it compares the write I/O request to the marker to determine whether the write I/O request is directed to RAID consistent data, in this case the LBA 311. Since the data is RAID consistent, in this example, the storage controller 11 implements the read-modify-write operation to write data to the LBA 311 and then compute the parity 315 based on that written data.

Again, the read-modify-write operation comprises two data writes and two data reads to compute the parity 315 and complete the write I/O request. The new parity 315 is generally equal to the new data at the LBA 311 XOR'd with the existing data at the LBAs 312, 313, and 314. Or, more simply written:
LBA 315_{new}=LBA 311_{new}+LBA 312_{old}+LBA 313_{old}+LBA 314_{old}
   (where the “+” symbols are intended to represent XOR operations).

### So,

LBA 315_{new}+LBA 311_{new}=LBA 312_{old}+LBA 313_{old}+LBA 314_{old}, and
LBA 315_{new}+LBA 311_{new}=LBA 315_{old}.

Since
LBA 315_{old}=LBA 311_{old}+LBA 312_{old}+LBA 313_{old}+LBA 314_{old} and
LBA 315_{old}+LBA 311_{old}=LBA 312_{old}+LBA 313_{old}+LBA 314_{old},
LBA 315_{new}+LBA 311_{new}=LBA 315_{old}+LBA 311_{old}.

Therefore,
LBA 315_{new}=LBA 311_{new}+LBA 315_{old}+LBA 311_{old},
   thus resulting in only two write operations and two read operations.

Turning now to FIG. 4, a read-peers-write operation is used to write to inconsistent data. Thus, it is to be assumed that one or more of the LBAs 321-325 comprises older data that makes the stripe 310 not consistent with the RAID storage management technique being implemented in the virtual drive 31. In this embodiment the host system 21 is requesting that data be written to the LBA 321 on the drive 30-1. Because one or more of the LBAs 321-325 comprises inconsistent data, the new parity at the LBA 325 is calculated from the new data at LBA 321 plus the existing data at the LBAs 322-325. Or, more simply written as:
LBA 325_{new}=LBA 321_{new}+LBA 322_{old}+LBA 323_{old}+LBA 324_{old}.
   This operation uses two data writes and four data reads. As one can see, the number of data reads increases with the number of drives 30 being used to implement the virtual drive 31. So, the read-peers-write algorithm is not as efficient as the read-modify-write algorithm in making the data in the virtual drive 31 RAID consistent.

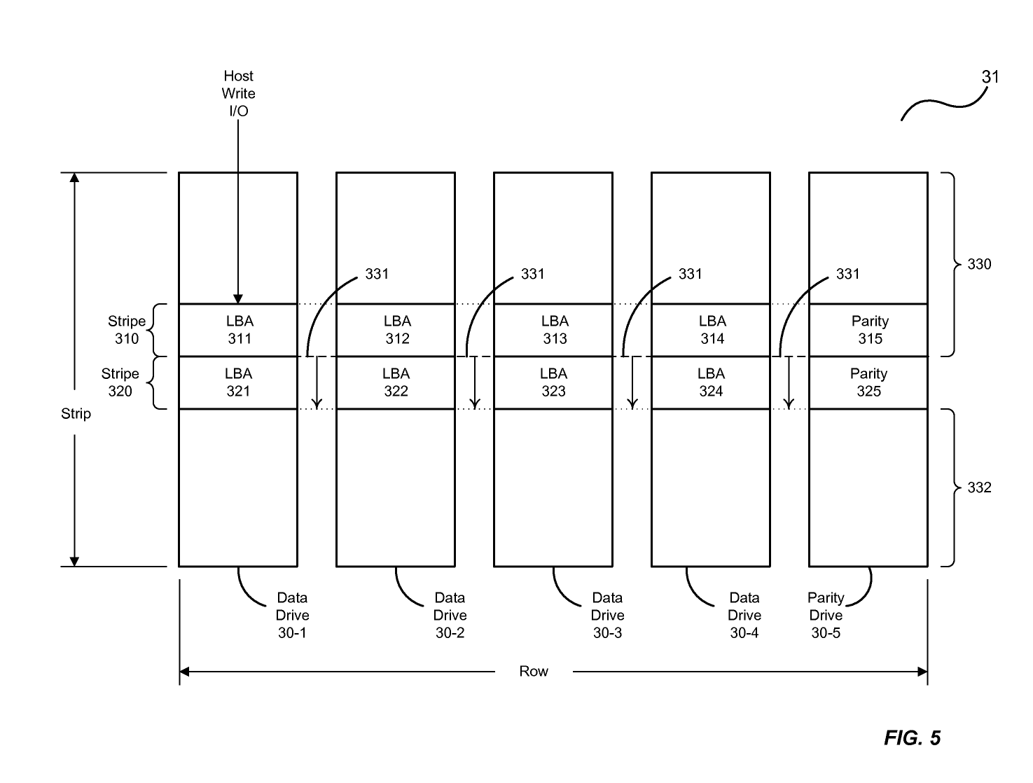

However, as the RAID storage controller 11 is operable to selectively implement the various write algorithms based on where the write I/O request by the host system 21 is directed, the RAID storage controller 11 can present the virtual drive 31 to the host system more quickly and improve I/O latency introduced by inconsistent data. A more detailed example of such is illustrated in FIG. 5.

In FIG. 5, the virtual drive 31 comprises both RAID consistent data (region 330) and data that is inconsistent with the RAID storage management technique being implemented (region 332). In this embodiment, the boundary between these two regions 330 and 332 is illustrated with the RAID stripes 310 and 320. The RAID storage controller 11 maintains a marker 331 that defines that boundary. Thus, when a write I/O request from the host system 21 is processed by the RAID storage controller 11 to any of the LBAs in the consistent data region 330, the RAID storage controller 11 can implement the read-modify-write operation to more quickly write the data.

If the write I/O request from the host system 21 is directed to inconsistent data in the region 332 (e.g., to one of the LBAs 321-324 of the stripe 320), then the RAID storage controller 11 implements the read-peers-write operation to write the data and make the stripe RAID consistent. Then, the RAID storage controller 11 moves the marker to indicate the new boundary between the RAID consistent data and the inconsistent data.

Again, the RAID storage controller 11 through its associated driver 23 may also operate in the background to make the physical drives of the virtual drive 31 consistent. Thus, any time the RAID storage controller 11 makes a stripe RAID consistent, whether it is through read-peers-write operations or through clearing all data, the RAID storage controller 11 is operable to adjust the marker accordingly to maintain the boundary between RAID consistent data and inconsistent data. Accordingly, the embodiments herein are operable to make the virtual drive 31 RAID consistent in smaller chunks and to make the virtual drive 31 available to the host system 21 sooner while also reducing host write latency for write I/O requests that overlap with cache flush operations, particularly when the virtual drive 31 is implemented in a write through mode. This, in turn, avoids host write timeouts observed by the OS 22 of the host system 21.

The invention is not intended to be limited to the exemplary embodiments shown and described herein. For example, other write operations may be used based on a matter of design choice. And, the selection of such write operations may be implemented in other ways. Additionally, while illustrated with respect to RAID level 5 storage, these storage operations may be useful in other RAID level storage systems as well as storage systems not employing RAID techniques. For example, the embodiments herein may use the marker to track the differences between old and new data so as to ensure that the old data is not accessed during I/O operations.

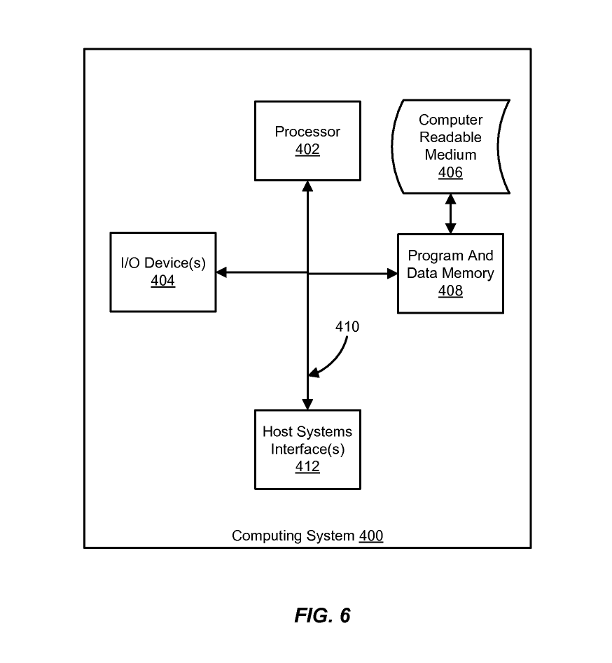

The invention can also take the form of an entirely hardware embodiment, an entirely software embodiment or an embodiment containing both hardware and software elements. In one embodiment, the invention is implemented in software, which includes but is not limited to firmware, resident software, microcode, etc. FIG. 6 illustrates a computing system 400 in which a computer readable medium 406 may provide instructions for performing any of the methods disclosed herein.

Furthermore, the invention can take the form of a computer program product accessible from the computer readable medium 406 providing program code for use by or in connection with a computer or any instruction execution system. For the purposes of this description, the computer readable medium 406 can be any apparatus that can tangibly store the program for use by or in connection with the instruction execution system, apparatus, or device, including the computer system 400.

The medium 406 can be any tangible electronic, magnetic, optical, electromagnetic, infrared, or semiconductor system (or apparatus or device). Examples of a computer readable medium 406 include a semiconductor or solid state memory, magnetic tape, a removable computer diskette, a random access memory (RAM), a read-only memory (ROM), a rigid magnetic disk and an optical disk. Some examples of optical disks include compact disk-read only memory (CD-ROM), compact disk-read/write (CD-R/W) and DVD.

The computing system 400, suitable for storing and/or executing program code, can include one or more processors 402 coupled directly or indirectly to memory 408 through a system bus 410. The memory 408 can include local memory employed during actual execution of the program code, bulk storage, and cache memories which provide temporary storage of at least some program code in order to reduce the number of times code is retrieved from bulk storage during execution. Input/output or I/O devices 404 (including but not limited to keyboards, displays, pointing devices, etc.) can be coupled to the system either directly or through intervening I/O controllers. Network adapters may also be coupled to the system to enable the computing system 400 to become coupled to other data processing systems, such as through host systems interfaces 412, or remote printers or storage devices through intervening private or public networks. Modems, cable modem and Ethernet cards are just a few of the currently available types of network adapters.

What is claimed is:

1. A method for storing data, the method comprising:
configuring a plurality of storage devices to operate as a Redundant Array of Independent Disks (RAID) storage system;
initiating the RAID storage system to process Input/Output (I/O) requests from a host system to the storage devices;
identifying where RAID consistent data exists after the RAID storage system is initiated;
performing read-modify-write operations for write I/O requests directed to the RAID consistent data according to a marker identifying where the RAID consistent data exists;
performing a different type of write operations for write I/O requests directed to the inconsistent data according to the marker in order to make the inconsistent data RAID consistent; and
adjusting the marker when the inconsistent data is made RAID consistent.

2. The method of claim 1, wherein:
the RAID storage system is a RAID level 5 storage system comprising at least 5 of the storage devices.

3. The method of claim 1, wherein:
the different write operations comprise read-peer-write operations; and
the method further comprises:
calculating RAID level 5 parity based on new data being written at one of a plurality of Logical Block Addresses of data in a stripe comprising inconsistent data; and
logically XORing the new data with the other Logical Block Address of data to calculate the RAID level 5 parity.

4. The method of claim 1, further comprising:
initiating the RAID storage system comprises clearing a first portion and a last portion of storage space of the RAID storage system in order to remove a master boot record from the RAID storage system.

5. The method of claim 4, wherein:
the first and last portions of the storage space of the RAID storage system comprise about 8 megabytes each.

6. The method of claim 1, further comprising:
clearing portions of the inconsistent data as a background process during write I/O operations to make the portions of the inconsistent data RAID consistent.

7. A non-transitory computer readable medium comprising instructions that, when executed by one or more processors in a Redundant Array of Independent Disks (RAID) storage system, direct the one or more processors to:
configure a plurality of storage devices to implement the RAID storage system;
initiate the RAID storage system to process Input/Output (I/O) requests from a host system to the storage devices;
identify where RAID consistent data exists after the RAID storage system is initiated;
perform read-modify-write operations for write I/O requests directed to the RAID consistent data according to a marker identifying where the RAID consistent data exists;
perform a different type of write operations for write I/O requests directed to the inconsistent data according to the marker in order to make the inconsistent data RAID consistent; and
adjust the marker when the inconsistent data is made RAID consistent.

8. The computer readable medium of claim 7, wherein:
the RAID storage system is a RAID level 5 storage system comprising at least 5 of the storage devices.

9. The computer readable medium of claim 7, wherein:
the different write operations comprise read-peer-write operations; and
the computer readable medium further comprises instructions that direct the one or more processors to:
calculate RAID level 5 parity based on new data being written at one of a plurality of Logical Block Addresses of data in a stripe comprising inconsistent data; and
logically XOR the new data with the other Logical Block Address of data to calculate the RAID level 5 parity.

10. The computer readable medium of claim 7, further comprising instructions that direct the one or more processors to:
initiate the RAID storage system comprises clearing a first portion and a last portion of storage space of the RAID storage system in order to remove a master boot record from the RAID storage system.

11. The computer readable medium of claim 10, wherein:
the first and last portions of the storage space of the RAID storage system comprise about 8 megabytes each.

12. The computer readable medium of claim 7, further comprising instructions that direct the one or more processors to:
clear portions of the inconsistent data as a background process during write I/O operations to make the portions of the inconsistent data RAID consistent.

13. A Redundant Array of Independent Disks (RAID) storage controller, comprising:
a storage interface operable to interface to a plurality of storage devices; and
an Input/Output (I/O) processor communicatively coupled to the storage interface, wherein the I/O processor is operable to initiate a RAID storage system on the storage devices, and to process I/O requests from a host system to the RAID storage system,
wherein the I/O processor is further operable to identify where RAID consistent data exists after the RAID storage system is initiated, to maintain a marker that identifies where RAID consistent data exists, to perform read-modify-write operations for write I/O requests directed to the consistent data according to the marker, to perform a different type of write operations for write I/O requests directed to inconsistent data according to the marker in order to make the inconsistent data RAID consistent, and to adjust the marker when the inconsistent data is made consistent.

14. The RAID storage controller of claim 13, wherein:
the different write operations comprise read-peer-write operations that calculate RAID level 5 parity based on new data being written at one of a plurality of Logical Block Addresses of data in a stripe comprising inconsistent data; and
the RAID level 5 parity is an XOR operation of the new data with the other Logical Block Address of data.

15. The RAID storage controller of claim 13, further comprising:
a driver operable with the host system that directs the RAID storage controller to clear regions of inconsistent data as a background process to make the regions consistent, and to adjust the marker after the regions have been made consistent.

16. The RAID storage controller of claim 13, wherein:
the driver is further operable to dynamically change sizes of the regions of inconsistent data being cleared and to adjust the marker accordingly.

17. The RAID storage controller of claim 13, wherein:
the I/O processor is further operable to clear a first portion and a last portion of storage space of the RAID 5 storage system in order to remove a master boot record from the RAID 5 storage system.

18. The RAID storage controller of claim 17, wherein:
the first and last portions of the storage space of the RAID 5 storage system comprise about 8 megabytes each.

19. The RAID storage controller of claim 13, wherein:
the RAID storage system is a RAID level 5 storage system comprising at least 5 of the storage devices.

20. A Redundant Array of Independent Disks (RAID) storage system, comprising:
a RAID storage controller driver operable within a host system to generate Input/Output (I/O) requests to a virtual drive; and
a RAID storage controller communicatively coupled to the driver and operable to partially initialize the virtual drive for storage operations by the host system,
wherein RAID storage controller is further operable to identify where the uninitialized portion of the virtual drive exists, to write data from the host system via the I/O requests to the initialized portion of the virtual drive using a read-modify-write operation, to write data from the host system via the I/O requests to the uninitialized portion of the virtual drive using a different write operation, and to track changes from the uninitialized portion of the virtual drive to the initialized portion of the drive based on the write operations.

21. The RAID storage system of claim 20, wherein:
the RAID storage controller driver is further operable to clear locations in the uninitialized portion of the virtual drive after the storage operations by the host system have commenced to initialize the locations, and to direct the RAID storage controller to update the changes from the uninitialized portion of the virtual drive to the initialized portion of the drive.

22. A method operable in a storage system, the method comprising:
partially initializing a virtual drive for storage operations by a host system,
generating Input/Output (I/O) requests to the virtual drive; and
writing data from the host system via the I/O requests to the initialized portion of the virtual drive using a read-modify-write operation;
processing the I/O requests to determine whether the I/O requests are directed to the uninitialized portion of the virtual drive; and
in response to determining that the I/O requests are directed to the uninitialized portion of the virtual drive:
writing the data from of the I/O requests to the uninitialized portion of the virtual drive using a different write operation; and
tracking changes from the uninitialized portion of the virtual drive to the initialized portion of the drive based on the write operations.

23. The method of claim 22, further comprising:
clearing locations in the uninitialized portion of the virtual drive after the storage operations by the host system have commenced to initialize the locations; and
directing a storage controller to update the changes from the uninitialized portion of the virtual drive to the initialized portion of the drive.

24. The method of claim 22, wherein:
the storage system is a RAID storage system.
